(19) United States
(12) Patent Application Publication
(10) Pub. No.: US 2026/0244463 A1
(43) Pub. Date: Aug. 20, 2026

(54) SYSTEM AND METHOD FOR DETERMINING AND EXECUTING USER-ASSOCIATED ACTIONS

(71) Applicant: Jagadeshwar Reddy Nomula, Sunnyvale, CA (US)

(72) Inventor: Jagadeshwar Reddy Nomula, Sunnyvale, CA (US)

(73) Assignee: Voiceemonk. Inc., Sunnyvale, CA (US)

(21) Appl. No.: 19/643,721

(22) Filed: Apr. 9, 2026

Related U.S. Application Data
(60) Provisional application No. 63/893,905, filed on Oct. 5, 2025.

(51) Int. Cl. G06F 9/451

(52) U.S. Cl. CPC G06F 9/451

(57) ABSTRACT

A system and method for determining and executing context-based actions are disclosed. User events consisting contextual information indicative of a user state are received from one or more devices associated with a user. The user events are stored in a temporal action memory as a time-ordered sequence with associated timestamps. Relevance values calculated for the user events using a time-based weighting function assigns higher relevance to more recent events. Contextual features representing a current user condition are extracted, and augmented context data is generated using the extracted contextual features and a predefined recent portion of the temporal action memory selected based on the relevance values. One or more next actions are predicted by processing the augmented context data using a trained model. The predicted next actions are evaluated using a predefined policy to determine a selected action, which is executed by transmitting a command to one or more user devices.

### CROSS-REFERENCE TO RELATED APPLICATION

This application claims the benefit of U.S. Provisional Application No. 63/893,905 filed on Oct. 5, 2025. This application is a continuation in part of Ser. No. 19/377,016 with publication number US20260057413A1 filed Nov. 2, 2025, Ser. No. 19/234,241, with publication number US 2025-0307876 A1 filed Jun. 10, 2025, Ser. No. 19/313,908 with title “SYSTEM AND METHOD FOR PRESENTING TARGETED CONTENT” filed on Aug. 10, 2025. The entire disclosures of all said prior applications are hereby incorporated by reference.

### BACKGROUND

### Field of Invention

The present disclosure relates generally to artificial intelligence systems, and more particularly to a user-specific artificial intelligence model configured to model user behavior and to automatically replicate and coordinate user actions and decisions across multiple software applications, hardware devices, and computing platforms.

### Discussion of Prior Art

Conventional computing systems and digital platforms typically require users to manually perform actions across multiple software applications and devices to complete routine tasks, workflows, and operations. Such systems rely on explicit user input for each action, including navigation, command execution, and decision-making, and generally operate in isolation within individual applications. While certain systems provide basic automation through scripts, macros, or predefined rules, these mechanisms remain limited to narrowly defined scenarios and lack the ability to adapt to changing user contexts or evolving behavioral patterns.

More recently, data-driven and model-based approaches, including those incorporating machine learning or large language model (LLM) techniques, have been explored to monitor user interactions and generate recommendations or suggested actions. However, such approaches predominantly rely on probabilistic inference over observed data and are typically oriented toward generating outputs in response to discrete prompts or queries. These systems often lack structured representations of user behavior over time, fail to reliably capture temporal dependencies and cross-application relationships, and are not inherently designed to coordinate execution of multi-step workflows across heterogeneous environments. As a result, they remain largely assistive or advisory in nature rather than capable of consistently driving autonomous, context-aware task execution.

Further, existing systems that attempt to automate user actions, including those augmented with machine learning models, face challenges related to scalability, adaptability, and coordination across heterogeneous platforms and devices. Differences in application interfaces, execution environments, and data representations limit the ability of such systems to generalize learned behaviours or to replicate complex workflows consistently. Additionally, the absence of unified behavioral modeling frameworks constrains their ability to maintain continuity across sessions, devices, and evolving user contexts.

Recent advances in generative AI and large language models have enabled more sophisticated behavioral modeling and action prediction. However, existing approaches typically operate as opaque components, are difficult to interpret or control, and remain insufficiently integrated with cross-application coordination and action execution mechanisms. Furthermore, few solutions address synthetic media generation with proper safety safeguards, disclosure mechanisms, and delegation-based authorization frameworks.

In light of the foregoing, there is a need for a system that can effectively learn and represent user behaviour over time and coordinate execution of user-associated actions across multiple applications, devices, and computing environments contextually and adaptively.

### SUMMARY OF THE INVENTION

In an embodiment, a system and method for determining and executing context-based actions are disclosed. The system includes a processor configured to receive a series of user events from one or more devices associated with a user. Each user event includes contextual information indicative of a state of the user. The processor stores the received user events in a temporal action memory by recording each user event in a time-ordered sequence with an associated timestamp and corresponding contextual information. The processor calculates a relevance value for each user event using a time-based weighting function that assigns higher relevance values to more recent user events than to older user events. The processor extracts contextual features from the contextual information, and the extracted contextual features correspond to a current condition of the user. The processor generates augmented context data based on the extracted contextual features and a predefined recent portion of the temporal action memory selected based on the assigned relevance values. The processor predicts one or more next actions by processing the augmented context data using a trained machine learning model. The processor evaluates the predicted next actions in accordance with a predefined policy to determine a selected action. The processor executes the selected action by transmitting a command to the one or more devices associated with the user.

### BRIEF DESCRIPTION OF DRAWINGS

Embodiments are illustrated by way of example and not limitation in the figures of the accompanying drawings, in which like references indicate similar elements and in which:

FIG. 1 illustrates a schematic overview of a system 100 for determining and executing context-based user action, in accordance with an exemplary embodiment;

FIG. 2 illustrates a block diagram of a server 110 within the system 100, in accordance with the exemplary embodiment;

FIG. 3 illustrates the system 300 for determining and executing context-based user action, in accordance with the exemplary embodiment.

FIG. 4A illustrates a training process 400 of a machine learning model, in accordance with the exemplary embodiment;

FIG. 4B illustrates a policy routing and action execution architecture 450, in accordance with the exemplary embodiment;

FIG. 5 illustrates a method 500 for determining and executing context-based user action, in accordance with the exemplary embodiment;

FIG. 6 illustrates a computing environment 600 for implementing and executing context-based user action, in accordance with the exemplary embodiment; and

FIG. 7 illustrates an exemplary hardware architecture 700 on which an embodiment(s) described herein may be implemented, in accordance with the exemplary embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practiced without these specific details. In other instances, well-known methods, procedures, and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Replication of user actions by systems constitutes an increasingly critical function in modern computing environments, particularly as users interact with a growing number of applications, devices, and digital services across personal, enterprise, and safety-sensitive domains. Effective replication directly impacts system usability, operational efficiency, decision consistency, and user trust. Conventional approaches to user automation and personalization have primarily relied on static user profiles, application-specific scripts, task-based agents, or short-horizon prediction models. While such methods provide limited automation and basic assistance, they are typically tightly coupled to specific applications or workflows, difficult to generalize across domains, and incapable of accurately replicating complex, evolving user behavior in real time. More recent approaches incorporating machine learning-based assistants or digital replicas offer improved expressiveness but frequently operate as opaque components, are difficult to interpret or control, and remain insufficiently integrated with cross-application coordination and action execution mechanisms. Furthermore, existing solutions typically maintain fragmented or centralized user models and permit only coarse-grained delegation, resulting in inconsistent behavior replication, constrained cross-domain reasoning, and increased exposure of sensitive personal data. As a result, current automation and delegation mechanisms fail to provide a unified, flexible, and real-time replication framework capable of modelling user behavior and performing coordinated actions on behalf of the user in a scalable, explainable, and privacy-preserving manner.

In view of the foregoing, there exists a need for improved systems and methods for scalable, real-time personal artificial intelligence model capable of maintaining a continuously evolving, long-term representation of a user's memories, preferences, goals, and behavioural patterns, and of fusing such user-specific knowledge with generalized machine learning models to enable proactive, context-aware, and explainable assistance across a plurality of applications, devices, and domains.

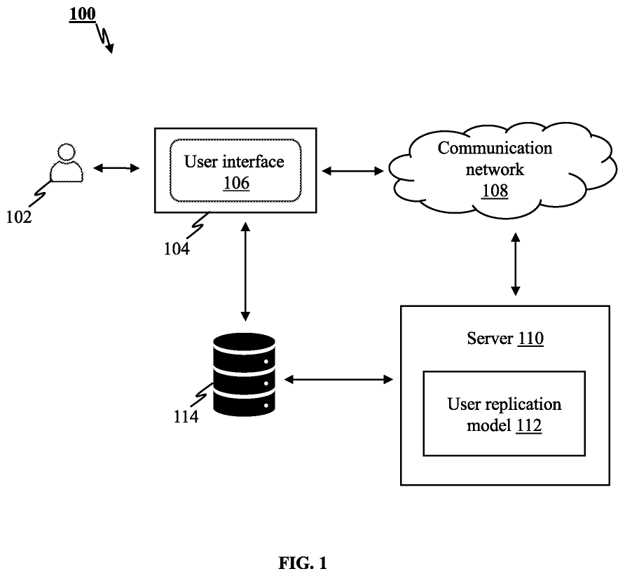

Referring to FIG. 1, an embodiment of a system 100 for determining, modeling, and executing context-based actions is disclosed. The system 100 may be configured to autonomously replicate and execute user-associated activities based on learned behavioural patterns, including routine, repetitive, conditional, and context-dependent tasks.

The system 100 may comprise one or more users 102 (hereafter user 102) operatively interacting with one or more user devices 104. The user device 104 may be any electronic computing device capable of executing software instructions, including, but not limited to, a desktop computer, laptop computer, mobile device, tablet, or workstation. Each user device 104 may include a user interface 106 configured to receive user inputs and present outputs through graphical interface elements and interactive controls.

The user device 104 may be communicatively coupled to a server 110 through a communication network 108. The communication network 108 may include, but is not limited to, wired or wireless networks, local area networks (LAN), wide area networks (WAN), or cellular networks, enabling bidirectional data exchange between the user device 104 and the server 110.

The server 110 may be configured to execute a user replication model 112, wherein the user replication model 112 receives, processes, and analyzes user interaction data generated through the user interface 106 of the user device 104. The user replication model 112 may interpret such interactions to determine patterns associated with user behaviour and to generate corresponding executable actions. As used herein, an “action” may refer to a functional replication of user behaviour, wherein a sequence of operations corresponding to user inputs, decisions, or workflows is automatically executed by the system 100, thereby enabling the system 100 to operate as a digital proxy for the user 102.

In an embodiment, the user replication model 112 may include one or more artificial intelligence models, including, but not limited to, a lifelong personal model (LPM) 242, a world action model (WAM) 240, machine learning models, large language models, neural networks, or robotic process automation modules.

The world action model (WAM) 240 may be configured to learn relationships between user context and user actions and to predict one or more likely next actions based on temporal sequences of user events and contextual information. The lifelong personal model (LPM) 242 may be configured to maintain a continuously evolving representation of the user 102, including behavioural preferences, communication styles, and historical interaction patterns over time. The LPM and the WAM may operate together such that predicted actions remain aligned with both observed behavioural patterns and user-specific characteristics.

The system 100 may further comprise a database 114 communicatively coupled to the user device 104 and the server 110. The database 114 may be configured to store user interaction data, action histories, application states, and contextual metadata. The user replication model 112 may access the database 114 to learn, update, and refine behavioural representations based on historical user activity across one or more applications and devices.

Based on the analyzed data, the user replication model 112 may generate one or more executable action representations, wherein each action representation may define execution logic corresponding to a user task. The action representations may include, but are not limited to, event sequences, workflow definitions, or state-transition representations. The user replication model 112 may automatically execute such actions in response to detected contextual conditions, predefined triggers, or inferred user intent.

In an exemplary embodiment, the actions may include, but are not limited to, participating in virtual meetings, responding to electronic communications, or controlling connected devices. For example, upon detecting a recurring sequence of events associated with a scheduled meeting, the user replication model 112 may coordinate execution of related actions across the user device 104 and external systems through the communication network 108, including launching an application, retrieving relevant information, and adjusting device settings. Accordingly, the system 100 may perform the action in a manner consistent with how the user 102 would have manually interacted with the user interface 106.

In an exemplary embodiment, the user 102 may perform an interaction through the user device 104 via the user interface 106, such as receiving a meeting notification or opening a communication application. Corresponding user event data, including contextual information and timestamps, may be transmitted through the communication network 108 to the server 110, where the user replication model 112 records the user event in a temporal action memory (TAM) 218 as part of a time-ordered sequence of prior user activities. The user replication model 112 may further process the recorded user event together with a subset of temporally relevant historical events retrieved from the temporal action memory to form an augmented contextual representation corresponding to a current condition of the user 102. Based on this representation, the world action model (WAM) 240 may predict one or more likely next actions consistent with previously observed behavioural patterns, while the lifelong personal model (LPM) 242 ensures alignment with user-specific preferences and characteristics. In response, the user replication model 112 may generate and execute one or more actions, including launching a meeting application, retrieving associated documents, and adjusting device settings on the user device 104, thereby replicating the expected behaviour of the user 102 in real time without requiring manual intervention.

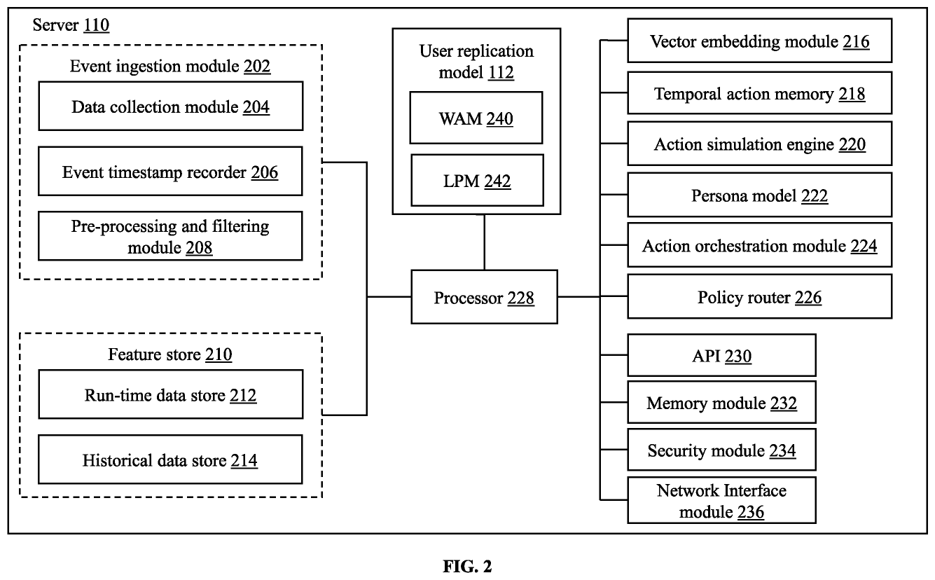

Referring to FIG. 2, an embodiment of an internal architecture of the server 110 is disclosed. The server 110 may be configured to execute a user replication model 112 using one or more processors 228. The user replication model 112 may operate through coordinated interaction of multiple modules configured to receive user event data, derive contextual representations, model behavioural patterns over time, predict one or more likely next actions, and execute selected actions on behalf of one or more users 102. The overall operation may follow a continuous pipeline in which incoming user events are progressively transformed into structured representations, evaluated against historical patterns, and converted into executable actions.

In an embodiment, the server 110 may include an event ingestion module 202 configured to manage acquisition and organization of user event data generated from one or more user devices 104 via the user interface 106. The event ingestion module 202 may operate in coordination with a data collection module 204, which may capture event records corresponding to interactions performed by the user 102 across a plurality of applications. Such event records may include, but are not limited to, user input actions, application identifiers, timestamps, device states, session information, and contextual metadata. For example, when the user 102 opens a messaging application, selects a notification, or interacts with a calendar entry, the data collection module 204 may capture corresponding event records and transmit such records to the event ingestion module 202 for further processing.

The data collection module 204 may be further configured to aggregate event records received as continuous or batch streams and to associate each event record with corresponding identifiers, including, but not limited to, user identifiers, device identifiers, and application identifiers. This association enables reconstruction of user activity across multiple devices and applications and may support correlation of distributed user interactions into unified activity sequences.

In an embodiment, each user event processed by the event ingestion module 202 may include, but is not limited to, application interaction events, user input actions, communication events, system-generated events, and device state changes. Such events may include actions such as opening or closing an application, selecting a user interface element, sending or receiving electronic communications, joining or leaving a meeting session, updating calendar entries, or interacting with connected devices.

In an embodiment, the server 110 may include an event timestamp recorder 206 that may operate in coordination with the data collection module 204. The event timestamp recorder 206 may be configured to add time information to user events as the events are received from the user device 104. When a user event occurs, the event timestamp recorder 206 records the time at which the user event is generated and associates the recorded time with contextual information collected for the user event. This time information may be stored as a timestamp for the user event and may enable the system 100 to maintain the chronological order of user activity. The event timestamp recorder 206 may also record additional timing information, such as when the user event is received by the server 110. By maintaining timestamped event records, the system 100 may support accurate reconstruction of user activity sequences across multiple applications and devices. For example, the user 102 may open an email application on a mobile device and later join a virtual meeting on a laptop. When each action occurs, the event timestamp recorder 206 may record the time of the action and associate it with the corresponding contextual data. The system 100 may then determine that the email interaction occurred before the meeting, even though the actions were performed on different devices.

In an embodiment, a pre-processing and filtering module 208 may be operatively coupled to the event timestamp recorder 206 and may process time-stamped user event records prior to further analysis. The pre-processing and filtering module 208 may perform data conditioning operations to improve data quality and consistency. Such operations may include, but are not limited to, verifying event source authenticity, validating data integrity, removing duplicate or redundant events, normalizing event data generated by different applications or devices, and correlating related events occurring within a common time window or user session. The pre-processing and filtering module 208 may further associate contextual attributes with the processed events and may exclude event records that are irrelevant, corrupted, or outside predefined relevance criteria. The resulting structured and cleansed event records may be provided to a feature store 210, a vector embedding module 216, and an action simulation engine 220 to support learning, prediction, and automated execution of user actions based on historical and current user behavior.

The processed event records may be transmitted to a feature store 210 configured to store structured feature data derived from the user events. The feature store 210 may include a run-time data store 212 and a historical data store 214. The run-time data store 212 may maintain features representing a current condition of the user 102, including active applications, recent actions, device state, and contextual indicators. The historical data store 214 may retain time-stamped event records and derived features over extended durations to support long-term behavioural analysis and model learning. For example, the run-time data store 212 may indicate that the user 102 is currently interacting with a communication application during working hours, while the historical data store 214 may indicate that similar contexts are frequently followed by joining scheduled meetings or accessing related documents. This separation enables the system 100 to simultaneously consider immediate context and long-term behavioural patterns.

In an embodiment, the vector embedding module 216 may transform time-stamped historical event records and real-time feature values into fixed-length vector representations. The vector representations may capture semantic meaning, temporal relationships, and contextual attributes associated with user behavior. The vector embedding module 216 may generate embeddings for individual events, ordered event sequences, tasks, or workflows using one or more embedding models. The one or more embedding models may include, but are not limited to, neural network encoders, transformer-based architectures, metric learning models, or domain-specific representation models.

The generated vector embeddings may be stored in an embedding index that supports similarity-based retrieval. Similarity search operations may be performed using embeddings derived from a current execution context or current user condition to identify historical event records, sequences, or task patterns that exhibit similar contextual features. By retrieving historically similar behaviors that remain relevant in time, the vector embedding module 216 supports identification of prior user actions that are indicative of likely next actions and consistent with observed user behavior.

In an embodiment, the vector embedding module 216 may further account for temporal relevance when evaluating similarity between vector embeddings. Similarity scores associated with stored embeddings may be adjusted based on elapsed time since the corresponding user events occurred. For example, embeddings associated with more recent events may retain higher influence than embeddings associated with older events. The vector embedding module 216 may compute an adjusted similarity score by combining a base semantic similarity measure with a time-based weighting factor derived from the event timestamps.

By incorporating temporal relevance into similarity evaluation, the vector embedding module 216 enables retrieval results that reflect a current condition of the user 102 rather than outdated behavioral patterns. This temporal weighting supports adaptive learning of evolving user preferences and workflows and improves accuracy of predicted and replicated actions generated by the user replication model 112.

In an embodiment, a temporal action memory 218 may be configured to store ordered sequences of user events along with associated contextual attributes. The temporal action memory 218 may maintain a time-indexed representation of user behaviour, including event ordering, transitions between actions, and temporal intervals between events. The temporal action memory 218 may maintain both short-term and long-term behavioural histories through one or more sliding temporal windows. The temporal action memory 218 may further apply temporal decay functions to adjust relevance of stored events, such that more recent events may exert greater influence than older events. Additionally, the temporal action memory 218 may detect changes in user behaviour over time and adjust stored representations accordingly. For example, if the user 102 modifies a recurring routine, the temporal action memory 218 may update the relative importance of prior patterns to reflect the updated behaviour. The temporal action memory 218 may provide a subset of contextually relevant event sequences to an action simulation engine 220. This subset may be selected based on relevance values, temporal proximity, and contextual similarity, thereby enabling efficient processing by limiting analysis to relevant behavioural data.

The action simulation engine 220 may be configured to process contextual features obtained from the feature store 210, vector representations generated by the vector embedding module 216, and temporal sequences obtained from the temporal action memory 218 to determine one or more likely next actions. The action simulation engine 220 may analyze relationships between user context and historical actions to infer behaviour consistent with previously observed patterns.

In an embodiment, the user replication model 112 may include the world action model (WAM) 240 and the lifelong personal model (LPM) 242 that operate in association with the action simulation engine 220. The world action model (WAM) 240 may be configured to learn relationships between contextual conditions and user actions and to predict one or more likely next actions based on temporal sequences of events. For example, upon detecting that the user 102 has opened a meeting notification, the WAM 240 may determine that the next likely actions include joining the meeting, opening related documents, or initiating communication.

The lifelong personal model (LPM) 242 may be configured to maintain a continuously updated representation of the user 102, including behavioural preferences, communication styles, and long-term interaction patterns. The LPM 242 may influence predicted actions to ensure alignment with user-specific tendencies. For example, if the user 102 typically joins meetings early or prefers specific applications, the LPM 242 may adjust predicted actions accordingly. In an embodiment, the WAM 240 and the LPM 242 may operate together such that predicted actions are both contextually appropriate and personalized to the user 102.

Following prediction of one or more actions, the user replication model 112 may determine whether execution of such actions is permitted. In an embodiment, authorization may be determined using a delegation token associated with the user 102, wherein the delegation token may define permitted actions, scope, and validity conditions. Upon verification that the delegation token is valid and that the predicted action falls within permitted scope, the system 100 may proceed with execution of the selected action. If the delegation token is invalid, expired, or outside defined scope, execution may be restricted or prevented.

In an embodiment, the action simulation engine 220 may assign confidence values to predicted actions based on similarity between current context and historical outcomes. The user replication model 112 may select an action for execution based on the confidence values and predefined policies. In an embodiment, the action simulation engine 220 may be trained on historical user behavior data to learn temporal patterns describing how user actions occur over time and how subsequent actions follow prior actions. When a new event or system stimulus is detected, the action simulation engine 220 may analyze the current contextual state of the user 102 together with learned temporal behavior patterns to infer a likely user response. Based on this analysis, the action simulation engine 220 may identify one or more candidate next actions that are consistent with previously observed user behavior and relevant to the current user condition.

In an alternate embodiment, the action simulation engine 220 may be implemented as the world action model (WAM). In this configuration, the action simulation engine 220 may include an encoder configured to map multi-modal user state inputs into latent state vectors, and a predictor network that operates exclusively in latent space to forecast future latent representations conditioned on candidate action vectors. A latent loss minimization module may optimize prediction accuracy directly in latent space without reconstructing raw sensory data. By operating in latent space rather than token space or pixel space, the action simulation engine 220 reduces computational overhead and improves inference latency relative to autoregressive generative models.

Having described the action simulation engine 220 and its role in predicting the one or more next actions, the execution of any such predicted action on behalf of the user 102 may further require a corresponding authorization framework to ensure that autonomous execution may be performed strictly within the bounds of explicit user consent and defined operational parameters. In an embodiment, prior to execution of any autonomous action, including activation of synthetic telepresence, or participation in a digital session on behalf of the user 102, the system 100 may verify a cryptographically signed delegation token issued by the user 102 or an enterprise identity provider. The delegation token may authorize the system 100 to act on behalf of the user 102 and may be associated with a specific session context. The delegation token may define time duration, and permission level, and may include a unique identifier and cryptographic binding to a user identity and device context to prevent misuse. The delegation token may further be linked to a consent ledger that associates authorized actions with applicable data retention policies.

Upon successful verification, the system 100 may execute the selected action, including activation of text, audio, or generative video components. If the delegation token is invalid, expired, revoked, or outside its authorized scope, execution may be blocked and any active session terminated. The system 100 may validate the delegation token using public-key cryptographic signature verification. For synthetic media outputs, the system 100 may enforce disclosure requirements and attach cryptographic metadata, with executed actions logged and traceable to the verified delegation token.

In further embodiments, the action simulation engine 220 may include one or more policy heads or control modules configured to evaluate and select among predicted actions, thereby ensuring that the actions executed by the system 100 are consistent with both user behavioral patterns and applicable system policy constraints. The action simulation engine 220 may include a sequence encoder, such as a transformer-based encoder, that processes an ordered sequence of recent user events, contextual signals, and derived features to generate a latent representation capturing temporal relationships and the current user condition. The policy heads may be configured to operate on this latent representation to compute confidence values or likelihood scores for each predicted action. The action simulation engine 220 may generate multiple candidate actions and associate each with a corresponding confidence value reflecting similarity between the current contextual state and historical outcomes associated with similar contextual features. The policy heads may then support selection of the action that best aligns with predicted user behavior and applicable system policy constraints, thereby enabling coherent, context-aware action selection.

In an embodiment, following selection of the action by the policy heads of the action simulation engine 220, the user replication model 112 may determine an appropriate execution pathway for carrying out the selected action. Rather than relying on a single execution mechanism, the system 100 may include a plurality of specialized execution components configured to perform different categories of actions, including text-based communication, audio-based interaction, user interface control, task planning, external tool invocation, or audio-visual content generation. The determination of which execution component to activate may be based on the predicted intent of the user 102, contextual features corresponding to the current condition of the user 102, recent behavioral patterns stored in the temporal action memory 218, and user-specific stylistic or preference attributes. By selectively activating one or more execution components relevant to the selected action, the user replication model 112 may improve operational efficiency, reduce unnecessary computational overhead, and enable component-specific validation prior to execution.

In an embodiment, the user replication model 112 may further structure the selected action into a standardized action representation prior to transmission to one or more external applications, platforms, or devices. The standardized action representation may define attributes including an action type, communication modality, intended recipients or targets, contextual parameters, and compliance indicators. Such structuring enables uniform downstream handling by the action orchestration module 224 and the API module 230 when interfacing with external systems. Where the selected action involves communicative replication or audio-visual generation, the system 100 may condition the output on user-specific behavioral characteristics to maintain consistency with historical interaction patterns while enforcing applicable policy constraints. The user replication model 112 may further incorporate confidence-based autonomy controls such that, when confidence values fall below predefined thresholds or when policy conflicts are detected, the system 100 may downgrade execution to a restricted mode, defer execution pending confirmation, or request user approval, thereby maintaining contextual alignment, safety, and traceability.

In an embodiment, the event ingestion module 202, the feature store 210, the vector embedding module 216, the temporal action memory 218, and the action simulation engine 220 may collectively form the user replication model 112. The user replication model 112 may be stored in a non-transitory computer-readable medium and may be continuously updated during operation of the system 100 as new user events are detected. Each newly detected event may be ingested, time-stamped, and incorporated into the feature store 210 and the temporal action memory 218, followed by generation or updating of corresponding vector representations by the vector embedding module 216. The action simulation engine 220 may update internal states or short-term memory based on the newly processed information, allowing the user replication model 112 to reflect a current contextual state while retaining historical behavioral patterns. This continuous update process enables the system 100 to adapt over time and maintain a personalized behavioral model for each user.

In an embodiment, a persona model 222 may define a plurality of personas, with each persona representing a distinct behavioral profile, capability set, or policy configuration. The persona model 222 may influence how the user replication model 112 interprets contextual information and selects actions by applying persona-specific preferences, constraints, or decision policies. The persona model 222 may activate, deactivate, or transition between personas based on contextual attributes, user preferences, or historical interaction data. In an alternate embodiment, the persona model 222 may support modular extension, allowing personas to be added, modified, or removed without altering the underlying architecture of the user replication model 112. During operation, the persona model 222 may enforce persona-specific behavior boundaries and communication styles to maintain contextual appropriateness and alignment with user expectations across different domains of use.

In an embodiment, an action orchestration module 224 may manage runtime coordination between incoming events and corresponding system actions within the user replication model 112. The action orchestration module 224 may monitor events received from the event ingestion module 202 and other system triggers and apply a decision policy to determine whether and how the system 100 responds. This determination may consider a current user state derived from contextual information stored in the feature store 210, recent activity sequences maintained in the temporal action memory 218, historically similar events identified from vector memory, and predicted outcomes generated by the action simulation engine 220. Based on this information, the action orchestration module 224 may determine an appropriate response and identify a persona from the persona model 222 or a specific system capability for handling the event.

In an embodiment, one or more processors 228 may be configured to control and manage overall operation of the system 100 and to execute the actions associated with the user replication model 112. The one or more processors 228 may be configured to process user inputs, manage data flows between system components, perform computational tasks required for persona selection and action determination, and coordinate execution of one or more actions on behalf of the user 102. Further, the one or more processors 228 may ensure synchronized functioning of all system modules, thereby enabling efficient, secure, and contextually appropriate performance of tasks associated with the user replication model 112.

In an embodiment, an API module 230 may be configured to provide a standardized interface for communication between the user replication model 112 and one or more external systems, applications, services, or hardware devices. The API module 230 may ensure secure transmission and receipt of data, commands, and status information associated with execution of one or more actions on behalf of one or more users 102. The API module 230 may further support integration with third-party platforms by exposing a set of authenticated endpoints, protocols, and data exchange formats to enable interoperability while maintaining data privacy and access control. In certain embodiments, the API module 230 may be configured to translate internal system outputs into externally compatible request formats and to convert external responses into structured inputs usable by the action orchestration module 224 and the persona model 222.

In an embodiment, a memory module 232 may be configured to store and manage data associated with operation of the user replication model 112 and one or more associated system components. The memory module 232 may be configured to store user profiles, historical data, user contextual information, persona configurations, policy rules, and model parameters required for execution of various system functions. Further, the memory module 232 may be configured to enable secure data access, retrieval, and updating by authorized system modules, while enforcing data privacy, encryption, and integrity constraints. The memory module 232 may thereby enable continuity, personalization, and accuracy in decision-making processes performed by the user replication model 112 and related modules.

In an embodiment, a security module 234 may be configured to ensure protection of data, communications, and system operations associated with the user replication model 112. The security module 234 may be configured to enforce authentication, authorization, and access control mechanisms to prevent unauthorized access to system resources, user data, and model parameters. The security module 234 may further be configured to implement encryption protocols for data at rest and data in transit, monitor system activities for potential security threats, and apply anomaly detection techniques to identify unauthorized or malicious actions. In certain embodiments, the security module 234 may support user-defined privacy settings and regulatory compliance requirements, thereby ensuring that processing of personal data associated with the user 102 is conducted in a secure and privacy-preserving manner.

In an embodiment, a network interface module 236 may be configured to enable communication between the user device 104 and one or more external devices, servers, or networked systems. The network interface module 236 may support transmission and receipt of data over one or more wired or wireless communication channels, including local area networks, wide area networks, or cloud-based infrastructures. The network interface module 236 may further be operable to manage data synchronization, remote model updates, and retrieval of external resources required for operation of the user replication model 112. Further, the network interface module 236 may cooperate with the security module 234 to ensure secure data exchange, thereby maintaining integrity, confidentiality, and availability of information transmitted across network connections.

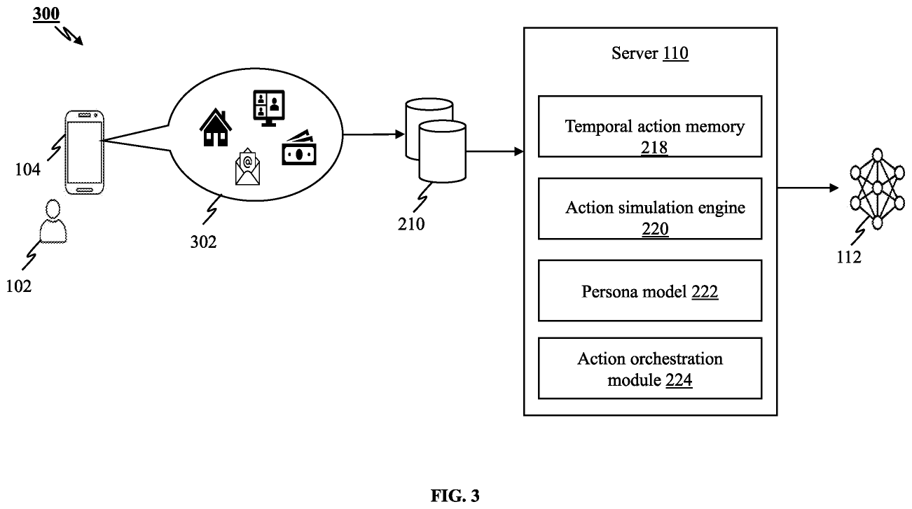

Referring to FIG. 3, an embodiment of a system 300 comprising the user replication model 112 is disclosed. The system 300 may include a user 102 interacting with a user device 104, wherein the user device 104 may generate user-related information 302 corresponding to activities performed across a plurality of applications and domains. The user-related information 302 may include, but is not limited to, data from communication applications, financial platforms, productivity tools, home automation systems, scheduling systems, and other digital services. Such user-related information 302 may represent interactions, behavioural patterns, preferences, contextual indicators, and activity states associated with the user 102.

In an embodiment, the user-related information 302 obtained from the plurality of applications on the user device 104 may be processed by the event ingestion module 202. The event ingestion module 202 may function as a secure interface through which the user-related information 302 may enter the system 300 and may detect an occurrence of each event at the user device 104. Upon detection, an occurrence time may be captured at a moment the user event is generated, and captured occurrence time may be linked with the contextual data associated with the user event included within the user-related information 302. Each event associated with the user-related information 302 may further be assigned the captured occurrence time as one or more temporal markers or timestamps by the event timestamp recorder 206 to preserve chronological order and contextual relevance.

In an embodiment, the user-related information 302 may further be filtered, normalized, and pre-processed by the pre-processing and filtering module 208 included within the event ingestion module 202 to remove redundant, incomplete, or irrelevant information while maintaining the linked contextual data and assigned timestamp. The event ingestion module 202 may record the user event along with the linked contextual data and assigned timestamp in an ordered sequence such that the plurality of user events are maintained in an order corresponding to their respective timestamps. By way of example, the user-related information 302 may include events such as email interactions, changes in device location, issuance of voice commands, application usage transitions, and other activity indicators associated with the user 102.

For example, the user-related information 302 like “email opened” “location changed at 12.05.03s” “voice command spoken” etc may be acquired by the event ingestion module 202.

In an embodiment, the processed user-related information 302 may be transmitted to the feature store 210. The user-related information 302 may include real-time data like active user queries such as a voice command requesting navigation assistance, recently updated feature values such as a change in user availability status, current application usage including an email application or messaging platform in active use, device status indicators such as battery level or connectivity state, and contextual markers including current geolocation coordinates, activity status indicating that the user 102 is driving or walking, or time-of-day classifications such as morning or late evening and historical data like records of prior email interactions, calendar scheduling patterns, frequently visited locations, past purchasing behavior across financial applications, communication logs, and previously executed device commands.

Upon storing the user-related information 302 in the feature store 210, a relevance value may be computed for each stored event record. For each event record, an elapsed time may be determined between a timestamp assigned to the user record and a current system time. The relevance value of the event record may be adjusted based on the elapsed time such that the event records with shorter elapsed times retain higher relevance values than the event records with longer elapsed times. The adjusted relevance values may be evaluated relative to a predefined relevance threshold indicative of whether the event record corresponds to the current condition of the user 102. Event records whose relevance values satisfy the predefined relevance threshold may be selected, while contextual data associated with stored event records whose relevance values fall outside the predefined relevance threshold may be excluded. The selected contextual data may then be aggregated to generate a unified contextual representation corresponding to the current condition of the user 102, thereby ensuring that system outputs remain aligned with current user preferences and behavioral trends.

In an embodiment, temporal sequences corresponding to the stored event records of the user-related information 302 may be recorded in the temporal action memory 218 in real time to maintain the event log capturing time-based relationships among user activities. A subset of stored event records may be detected based on their respective relevance values such that the subset corresponds to the current condition of the user 102, and the detected subset may be ordered according to the assigned timestamps. The temporal action memory 218 may further identify recurring action transitions performed by the user 102, such as accessing an email application followed by opening a calendar application within a predefined time interval, and may store statistical measures including transition probabilities, frequency counts, or occurrence distributions over defined time windows. The ordered subset of user events may be integrated with extracted contextual features to form a consolidated context representation reflecting both recent activity and learned temporal patterns.

In an embodiment, the action simulation engine 220 may operate in association with the WAM 240 and the LPM 242. The WAM 240 may be configured to model relationships between contextual conditions and user actions and to generate predictions of likely next actions based on temporal sequences of events. The LPM 242 may be configured to maintain a continuously evolving representation of the user 102, including preferences, communication styles, behavioural tendencies, and long-term interaction patterns. The WAM 240 and the LPM 242 may operate together such that predicted actions are both contextually relevant and aligned with user-specific characteristics. For example, the action simulation engine 220 may learn behavioral correlations indicating that receipt of a meeting-related communication is frequently followed by accessing a calendar application, scheduling a reminder, or initiating a response message by the user 102. In another example, detection of a low device battery level during working hours may be correlated with subsequent actions such as enabling a power-saving mode or connecting the user device 104 to a charging source.

Based on the one or more predicted future states of the user 102 derived from the correlated temporal patterns, the event record and associated contextual data may be routed to the persona model 222 associated with performing the predicted future states. For example, when sensor data or contextual indicators suggest that the user 102 is operating a vehicle, the event record may be routed to the persona model 222 associated with a driving or safety-focused operational context to suppress or defer non-essential notifications, prioritize navigation-related or urgent communications, and limit user interactions so as to minimize potential distractions and enhance operational safety. In certain embodiments, a trained classification model may be employed to predict an appropriate persona model 222 for handling a given event based on historical interaction data, contextual similarity measures, inferred user preferences, and the unified contextual representation corresponding to the current condition of the user 102.

Upon selection of the persona model 222, the action orchestration module 224 may be configured to ensure activation of the selected persona model 222 on the user device 104. Where the selected persona model 222 is not currently active, the action orchestration module 224 may load or initialize the persona model 222 by retrieving relevant model parameters, configuration data, and contextual information required for the task. By way of example, the persona model 222 configured for work-related activities may manage office communications, meeting scheduling, document handling, and productivity tasks; the persona model 222 configured for social interactions may facilitate messaging, social media engagement, and conversational assistance; the persona model 222 configured for home management may coordinate connected devices, environmental controls, and automated routines; and the persona model 222 configured for financial management may assist with budgeting, transaction monitoring, bill payments, and purchasing decisions. Each persona model 222 may share access to contextual data and memory resources maintained by the user replication model 112, enabling coordinated, domain-aware operation.

In an embodiment, the action orchestration module 224 may support concurrent activation of multiple persona models 222 when required by the user's actions or contextual state. For example, while the user 102 is engaged in family-related activities, a home-focused persona may manage domestic tasks or monitor household sensors, while a work-focused persona simultaneously participates in a virtual meeting on the user's behalf. Each persona model 222 may operate in coordination through the user replication model 112 to ensure consistency of contextual understanding and synchronized behavior across domains.

In an embodiment, the action orchestration module 224 may further support concurrent operation of multiple persona models 222 responsive to a plurality of user events or contextual requirements. Where the user 102 is associated with distinct domains of activity, the action orchestration module 224 may activate and coordinate multiple persona models 222 in parallel, each operating within its designated domain while accessing shared contextual data maintained by the user replication model 112. Each persona model 222 may process domain-specific events while synchronizing temporal action memory, contextual features, and predicted next actions to ensure consistency across domains.

In an embodiment, the action orchestration module 224 may manage inter-persona coordination through shared access to the action simulation engine 220 and the temporal action memory 218 maintained by the user replication model 112. The action orchestration module 224 may enable information exchange between the persona model 222 by recording structured events within the temporal action memory 218 that are readable by other persona models. When the persona model 222 performs or schedules an action, such as updating a calendar entry, the action orchestration module 224 may update shared contextual data within the user replication model 112, thereby propagating the updated state across persona models. Each persona model 222, upon detecting updated contextual features or future scheduled events, may generate proactive candidate actions consistent with the updated context.

Upon routing an event to the persona model 222, the persona model 222 may encode the current context of the user 102 by combining the most recent interaction, selected entries from the temporal action memory 218 weighted according to calculated relevance values and extracted contextual features corresponding to the current condition of the user 102. Based on this encoded and augmented context data, the persona model 222 may generate one or more predicted next actions. For each predicted next action, the persona model 222 may determine a confidence value based on a similarity between the augmented context data and historical outcomes associated with similar contextual features. The predicted next actions and associated confidence values may be transmitted to the action orchestration module 224 for evaluation.

The action orchestration module 224 may evaluate the predicted next actions in accordance with predefined policies, safety constraints, privacy rules, and user-specific autonomy settings. Confidence values associated with predicted next actions that satisfy the predefined policy requirements may be compared to detect a highest confidence value among the compliant actions. The predicted next action associated with the highest confidence value may be selected for execution. Where confidence and autonomy thresholds are satisfied, the selected action may be executed automatically; otherwise, the action may be presented to the user 102 for confirmation, deferred, modified, or discarded.

In an embodiment, the user replication model 112 may further be configured to replicate communicative and behavioral characteristics of the user 102 when the user 102 is unavailable or concurrently engaged. The action orchestration module 224 may verify contextual requirements for such replication and activate audio-visual generation components integrated with the user replication model 112. Latent representations corresponding to predicted future state transitions and selected actions may be generated and combined with user-specific prosodic features, facial landmark priors, pose estimations, and historical biometric samples. These representations may be converted into controllable signals for video generation modules configured for audio-driven portrait animation or text-to-video synthesis, including synchronization mechanisms to ensure temporal alignment between generated speech and facial motion, thereby producing a photorealistic representation consistent with the behavioral and communicative style of the user 102.

In an alternate embodiment, the WAM 240 may be implemented as a joint-embedding predictive architecture configured to generate latent representations of future state-action pairs. The WAM 240 may operate on contextual embeddings derived from temporal action memory 218 and current context, and may be trained using supervised and self-supervised learning techniques. Further, the WAM 240 may be fine-tuned using user-specific data to adapt predictions to individual behaviour. Further, the WAM 240 may be trained using a combination of supervised learning objectives (predicting observed next actions from context) and self-supervised learning objectives (predicting unobserved future states to encourage representation learning). The WAM 240 is then initialized with base parameters trained on large-scale, cross-user behavioral data, then fine-tuned on user-specific interaction logs using parameter-efficient techniques such as low-rank adaptation (LoRA) to preserve general knowledge while adapting to individual user patterns.

In an alternate embodiment, a Mixture-of-Experts routing mechanism may be employed to route tasks to specialized action experts. The routing mechanism may select a subset of experts based on contextual features and predicted actions, thereby improving computational efficiency and interpretability.

In an alternative embodiment, the architecture comprises a plurality of specialized action experts, including but not limited to a text expert configured to generate written communications such as emails, messages, or document edits; an audio/text-to-speech (TTS) expert configured to synthesize speech or audio outputs; a user interface (UI) action expert configured to generate interface control actions including, but not limited to, clicks, scrolling operations, form filling, and keyboard inputs; a tool-use expert configured to decompose complex tasks into a sequence of sub-tasks and to select and invoke appropriate tools or application programming interfaces (APIs); and a generative video expert configured to synthesize video outputs representing user communication activities. Each specialized action expert may comprise a learned model having an internal architecture including, but not limited to, transformer-based decoders, diffusion-based generators, or other neural network structures, and is trained to produce outputs within its respective modality.

In an alternate embodiment, the MoE router may be configured to employ either a learned gating function or one or more predefined rules to determine selection of the plurality of specialized action experts. The learned gating function may be configured to analyze contextual features associated with an input task/action and to route the task/action to a corresponding expert based on the analyzed features. For example, the task/action involving generation of an email may be routed to the text expert, whereas the task/action involving completion of a form may be routed to the UI-action expert. In an embodiment, the MoE router further comprises a load balancing component configured to distribute tasks or actions across the experts. The load balancing component operates to mitigate over-assignment of tasks to any single expert, thereby reducing potential processing delays and avoiding underutilization of other experts. Further, the MoE router may be trained using one or more auxiliary loss functions configured to guide expert selection. The auxiliary loss functions may promote sparse activation by encouraging selection of only a limited subset of experts for a given task or action, thereby improving clarity and interpretability of routing decisions. Additionally, the auxiliary loss functions may discourage persistent under-selection of certain experts, thereby facilitating more balanced utilization during training and enabling the experts to develop distinct functional specializations.

In an embodiment, the architecture further comprises a Generic Output Layer (GOL) operatively coupled to the experts and may be configured to normalize and structure outputs generated by the experts into a canonical typed action schema. Rather than permitting each expert to produce outputs in a distinct or incompatible format, each expert may be configured to generate outputs conforming to a predefined interface associated with the GOL, thereby enabling standardized downstream processing.

In an embodiment, the canonical typed action schema may comprise a structured representation including one or more fields, such as an action_type, a target application identifier, one or more parameters, optional temporal constraints, and a confidence value indicative of the reliability of the generated action. In some embodiments, the typed action schema may support multiple action categories, including, but not limited to, communicative actions comprising fields such as recipient, subject, body content, tone, and delivery method; user interface (UI) actions comprising fields such as target element identifiers, action types including click, scroll, or text input, and associated parameters; and meeting or scheduling actions comprising fields such as participant identifiers, duration, agenda, and scheduling constraints.

In an embodiment, the canonical typed action schema generated by the GOL may be provided to one or more application adapters configured to translate the structured actions into platform-specific commands for execution by external applications or services. Each of the one or more application adapter may be associated with a respective target platform, application, or web browser environment, and may convert the canonical representation into one or more executable instructions compatible with the target environment. The one or more application adapters may translate the typed action schema into platform-specific application programming interface (API) calls, user interface automation commands, scripting instructions, or other execution mechanisms supported by the corresponding platform. This abstraction layer enables the system to maintain a unified internal action representation while supporting interoperability across heterogeneous external systems, thereby decoupling expert output generation from platform-specific execution requirements.

In an alternate embodiment, the system 100 comprises a Latent Guidance Bridge (LGB) operatively coupled to the WAM 240, the LPM 242, and a text-to-speech (TTS) processing module. The LGB may be configured to transform and integrate the latent representations generated by the WAM 240, identity and style features derived from the LPM 242, and prosodic features generated by the TTS processing module into one or more conditioning signals for a generative video model. In an embodiment, the WAM 240 may be configured to generate latent action representations corresponding to predicted user intent, behavior, or actions. In parallel, the LPM 242 may be configured to provide identity and style encodings, including but not limited to facial structure, appearance attributes, and characteristic mannerisms, as well as higher-level stylistic attributes including speaking patterns, gesture tendencies, and emotional expression profiles and others known to a person skilled in the art. The TTS processing module, which may include a neural codec-based architecture, may be configured to generate speech-aligned features including phoneme sequences, fundamental frequency, energy contours, and temporal duration parameters.

Further, the outputs of the WAM 240, LPM 242, and TTS processing module may be provided to the LGB, which may be configured to perform cross-modal alignment and fusion of the received representations. In particular, the LGB may apply cross-attention mechanisms, pose or landmark priors, and style offset transformations to produce a temporally coherent and semantically aligned conditioning representation. The LGB may further be configured to incorporate guardrail constraints to regulate permissible variations in identity, expression, and motion. The resulting unified conditioning vector may encode action intent, identity, stylistic attributes, and speech dynamics, and may be provided as input to the generative video model configured to synthesize video frames representing the user performing actions consistent with the predicted behavior and communication context.

In an embodiment, the generative video model may comprise an audio-driven portrait generator or a diffusion-based video synthesis model configured to generate temporally consistent video outputs conditioned on the LGB representation. The generative video model may be trained using a plurality of coordinated objectives to ensure output quality, consistency, and safety. A lip-synchronization discriminator may be configured to enforce alignment between generated facial movements and corresponding audio signals derived from the TTS processing module. An identity preservation loss may be applied to maintain consistency of identity-specific features across generated frames and across multiple sessions. An expression alignment loss may further be employed to ensure that generated facial expressions and gestures correspond to the intended emotional and behavioral signals encoded within the conditioning representation.

In some embodiments, additional safety and policy enforcement mechanisms may be applied during or subsequent to video generation. Such mechanisms may include safety and policy gates configured to evaluate generated content with respect to predefined constraints, including content category restrictions and liveness characteristics. The generated video may further be processed by an on-frame disclosure component configured to embed visual indicators, including watermarks or textual labels, identifying the content as synthetically generated. Additionally, provenance metadata, including cryptographic signatures or hash-based records, may be embedded within the video to enable verification of authenticity and chain-of-custody. The processed video output may then be transmitted to an external interface, such as a WebRTC-based conferencing adapter, for real-time or asynchronous delivery.

In an embodiment, the system 100 further comprises a cryptographic delegation framework configured to enable fine-grained authorization and controlled execution of autonomous actions. The framework employs one or more delegation tokens, each comprising a signed credential issued by the user 102 or an enterprise identity provider, which may authorize the system or an associated agent to perform the actions within a defined scope, temporal validity, and permission level. Each delegation token may comprise a structured set of fields including but not limited to, a token identifier (token_id), an issuer field identifying the user or enterprise identity provider that issued the token; a subject field identifying the system component or agent authorized to act; issuance and expiration timestamps (issued_at and expires_at) defining a validity interval; an actions_allowed field specifying one or more permitted action types or operations, including but not limited to sending communications, attending meetings, or modifying documents; a scope field defining operational constraints, including limits on recipients, permitted applications, or temporal restrictions such as time-of-day; and a cryptographic signature generated over the preceding fields to ensure authenticity and integrity of the token.

In an embodiment, prior to execution of any autonomous action, the system 100 may be configured to perform a validation process to determine whether a valid and non-expired delegation token authorizes the requested action. The validation process includes verification of the cryptographic signature, evaluation of the validity interval, and confirmation that the requested action complies with the actions_allowed and scope constraints defined within the token. Upon successful validation, the system 100 proceeds with execution of the action and records the execution in association with the corresponding delegation token.

The system 100 further comprises a consent ledger configured to maintain an immutable and auditable record of authorized actions and corresponding outcomes. The consent ledger records, for each action, at least the associated delegation token identifier, the executed action, the execution outcome, and any subsequent user feedback, modification, or reversal. The consent ledger thereby provides a verifiable audit trail for compliance, enabling users, administrators, or auditors to review system behavior, validate authorization decisions, and detect potential misuse or unauthorized activity.

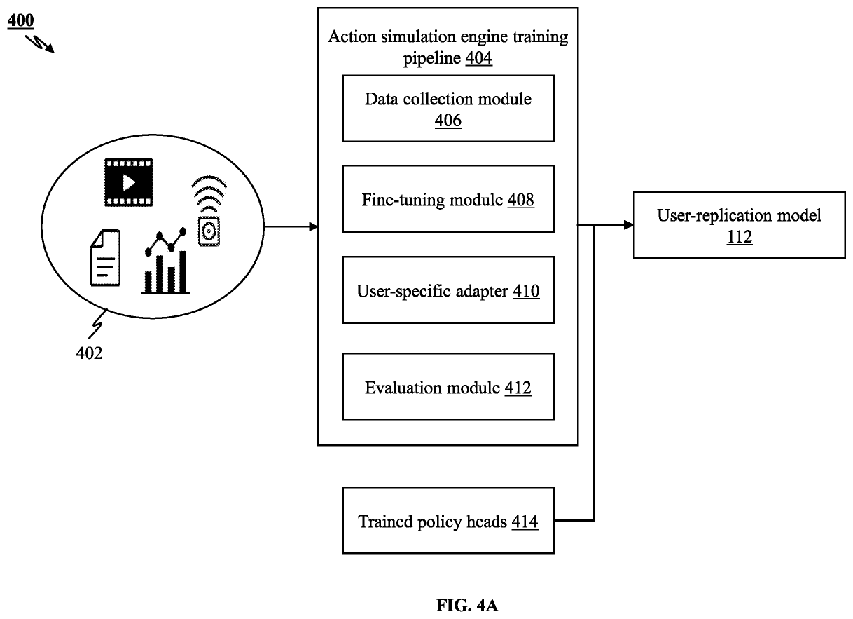

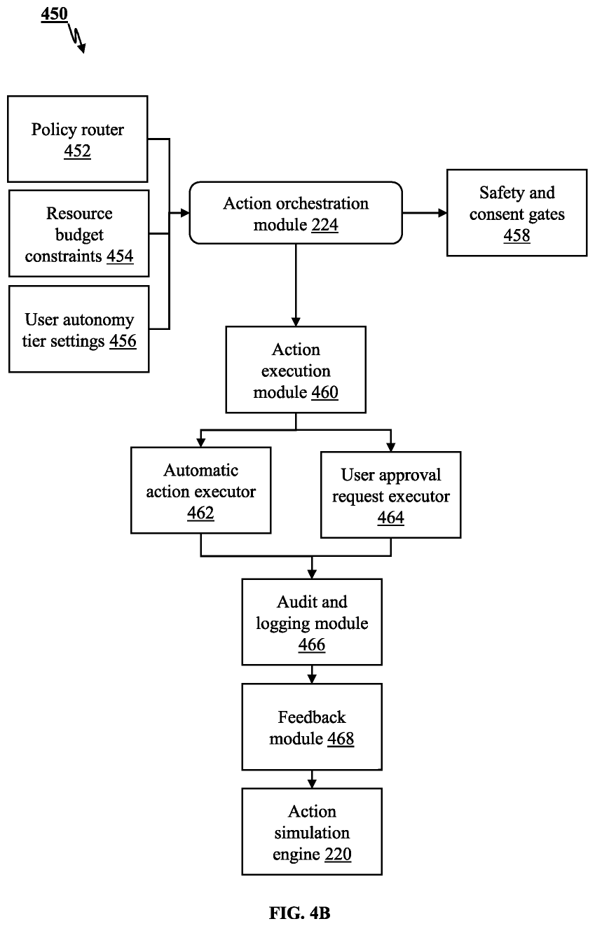

Referring to FIG. 4A in an embodiment, the training 400 of the user replication model 112 is disclosed. In an initial phase, the action simulation engine training pipeline 404 may form pre-training of the action simulation engine 220 through a large-scale input training data 402. The large-scale input training data 402 may include, without limitation, in-the-wild video data, text transcripts, user interaction logs, sensor data, and application usage records representing diverse world dynamics and action sequences. The pre-training may be performed using unsupervised, self-supervised, or semi-supervised learning techniques, including without limitation, masked prediction, sequence modeling, next-state prediction, or temporal contrastive learning, such that the action simulation engine 220 may learn temporal dependencies, causal relationships, and generalized priors over sequential events indicative of “what typically occurs next” given a contextual state using the large-scale input training data 402. The action simulation engine 220 may thereby learn environment transition representations analogous to reinforcement learning contexts but adapted for personal user contexts incorporating multi-modal behavioral data.

In certain embodiments, policy heads may be jointly trained with the action simulation engine 220 during the pre-training or in a subsequent stage. Such trained policy heads 414 may be configured to generate candidate actions leading to desirable outcomes based on learned world dynamics. Training of the policy heads may employ reinforcement learning, imitation learning, or goal-conditioned training on simulated or recorded user task scenarios. At this stage, the generated policies may represent generalized action-selection strategies applicable across broad user populations and may not yet incorporate user-specific personalization.

Subsequently, the action simulation engine 220 may undergo domain-specific fine-tuning by the fine-tuning module 408 to adapt the user replication model 112 to particular operational verticals. Such verticals may include, without limitation, enterprise workflow management, smart home or IoT environments, financial transaction processing, healthcare coordination, or communication management. During this phase, supervised datasets, domain-constrained simulations, or structured action logs may be utilized to refine performance on domain-relevant tasks.

In an embodiment, personalization of the user replication model may be achieved by the fine-tuning module 408 using parameter-efficient fine-tuning (PEFT) techniques applied to user-specific data. In such embodiments, parameters of the action simulation engine 220 remain fixed, while the fine-tuning module 408 may learn a limited set of user-specific parameters representing incremental adjustments relative to the user replication model 112. This approach avoids modification or duplication of the user replication model 112 for each user 102 and reduces storage and computational requirements.

In an embodiment, the fine-tuning module 408 may implement a low-rank adaptation technique in which trainable low-dimensional matrices may be inserted into one or more layers of a transformer-based architecture of the action simulation engine 220. The low-rank matrices may be trained using gradients derived from the user-specific data to adjust intermediate activations without altering weights of the user replication model 112.

In an alternate embodiment, the fine-tuning module 408 may apply quantized low-rank adaptation, wherein the user replication model 112 may be quantized to a reduced numerical precision, including a 4-bit representation, and personalization parameters are trained within the quantized parameter space. Further, the fine-tuning module 408 may train the user-specific parameters using a limited corpus of user data, including recent interaction events, historical usage patterns, documents, messages, and other communication records associated with the user 102. The resulting trained parameters define a user-specific adapter 410 that represents a differential parameter set relative to the user replication model 112. The user-specific adapter 410 may include only a small number of effective parameters relative to the user replication model 112 and may be generated using modest computational resources.

In an embodiment, the training of the user-specific adapter 410 may be performed periodically or conditionally, including during scheduled processing intervals or in response to detection of changes in user behaviour. Upon completion of training, the user-specific adapter 410 may be deployed to the user device 104 and applied at runtime in conjunction with the user replication model 112, thereby enabling the user replication model 112 to generate outputs that reflect user-specific preferences, stylistic tendencies, and behavioural patterns.

In an embodiment, the evaluation module 412 may be configured to assess performance of the user replication model 112 before and after deployment of the user-specific adapter 410. The evaluation module 412 may monitor user feedback signals, including corrective actions, rejected recommendations, explicit ratings, or implicit behavioural indicators. Such feedback may be logged and used as training signals by the fine-tuning module 408 to adjust personalization parameters.

In an embodiment, the evaluation module 412 may perform reinforcement learning from feedback by penalizing model behaviours that lead to undesirable outcomes and reinforcing behaviours associated with successful task completion. The evaluation module 412 may further compute performance metrics, including rollout accuracy, prediction success rates, and goal-completion metrics, based on simulated or historical interaction sequences. These metrics may be used to guide subsequent fine-tuning iterations.

Further, privacy-preserving techniques may be employed throughout the training and evaluation, including data anonymization, federated learning, or training on aggregated data. A cross-device consolidation service may be used to aggregate learning signals across multiple devices associated with the user 102, while sensitive user data may be stored in a secure privacy vault that is inaccessible to model training processes. As a result, personalization may be achieved while maintaining user data confidentiality and security.

Referring to FIG. 4B, in an embodiment, the coordination among a plurality of policy, resource, and autonomy control components that collectively govern whether and how the selected action may be executed on behalf of the user 102. The autonomous actions may be evaluated against applicable constraints prior to execution and that execution outcomes are systematically recorded and fed back to predictive components of the system 100.

In an embodiment, the action orchestration module 224 may receive inputs from at least three concurrent control streams. The first control stream may comprise a policy router 452 configured to apply a set of predefined and dynamically updated policy rules to classify the selected action and determine whether execution may be permissible under applicable behavioral, security, and compliance policies. The policy router 452 may evaluate the selected actions against categories of permitted operations, assess alignment with user-defined preferences, and apply domain-specific policy constraints derived from enterprise, legal, or contextual requirements.

In an embodiment, the second control stream may comprise resource budget constraints 454 configured to evaluate whether the execution of the selected actions may be feasible within currently available computational, network, and device resource budgets. The resource budget constraints 454 may monitor, including but not limited to, processor utilization, memory availability, network bandwidth, battery state, and other operational parameters of the user device 104 and the server 110. If resource availability is insufficient to support full execution of the selected actions, the resource budget constraints 454 may trigger a deferred execution mode, reduce the scope of the selected actions, or activate a lower-cost execution pathway.

In an embodiment, the third control stream may comprise user autonomy tier settings 456 configured to enforce the level of autonomous operation authorized by the user 102 for a given operational context. The user autonomy tier settings 454 may define one of three autonomy levels: an “Observe Only” level, at which the system 100 may be authorized to monitor and log user activity but not to execute any autonomous actions; a “Prompt-then-Act” level, at which the system 100 may be authorized to propose the one or more candidate actions to the user 102 and execute only upon receiving explicit user approval; and an “Autonomous” level, at which the system 100 may be authorized to execute the selected actions automatically without requiring per-action user confirmation, subject to the policy constraints enforced by the policy router. The active autonomy tier may be configured by the user 102 globally or on a per-domain or per-context basis.

In an embodiment, the selected actions approved by the policy router 452 and satisfying both the resource budget constraints 454 and the applicable autonomy tier setting 456 may be forwarded to safety and consent gates 458. The safety and consent gates 458 may perform a final pre-execution evaluation to verify that the selected actions do not violate safety constraints, privacy rules, or consent boundaries established by the user 102 or applicable regulatory frameworks. The safety and consent gates 458 may evaluate the selected actions against content safety classifiers, privacy exposure assessments, and consent scope defined within active delegation tokens. The selected actions that fail the safety and consent gate evaluation may be rejected, logged, and reported to the user 102 without execution.

In an embodiment, the selected actions that successfully pass through the safety and consent gates 458 are forwarded to an action execution module 460. Based on the applicable autonomy tier and the outcome of user approval processes, the action execution module 460 may route the selected actions to one of two execution pathways. Under the “Autonomous” autonomy tier, the selected actions may be forwarded to an automatic action executor 462, wherein the system 100 may execute the selected action directly without soliciting user confirmation. Under the “Prompt-then-Act” autonomy tier, the selected action may be forwarded to a user approval request executor 464, wherein the system 100 presents the proposed action to the user 102 via the user interface 106 and awaits explicit confirmation or rejection before proceeding with execution.

In an embodiment, regardless of the execution pathway taken, all executed actions are recorded by an audit and logging module 466. The audit and logging module 466 may maintain an immutable and timestamped record of each executed action, including the associated action type, execution pathway, delegation token identifier, execution outcome, and any user-provided feedback or modification. The records maintained by the audit and logging module 466 may be accessible to authorized administrators and the user 102 for compliance review, behavioral analysis, and error investigation. The audit and logging module 466 thereby ensures end-to-end traceability of all autonomous actions performed by the system 100.

In an embodiment, execution outcomes recorded by the audit and logging module 466 are forwarded to a feedback module 468. The feedback module 468 may be configured to process execution outcomes, including successful completions, user modifications, user rejections, and error states. Upon processing, the feedback module 468 may generate one or more structured feedback signals and transmit such feedback signals directly to the action simulation engine 220. Specifically, the feedback signals generated by the feedback module 468 may be routed as a directed input to the action simulation engine 220, wherein the action simulation engine 220 receives the feedback signals as a dedicated input stream. Upon receipt of the feedback signals from the feedback module 468, the action simulation engine 220 may utilize such signals to update policy head weights in response to confirmed or rejected action outcomes, refine confidence estimations based on observed execution results, adjust autonomy tier recommendations to reflect evolving user preferences, and improve the accuracy of predicted actions in future operational cycles.

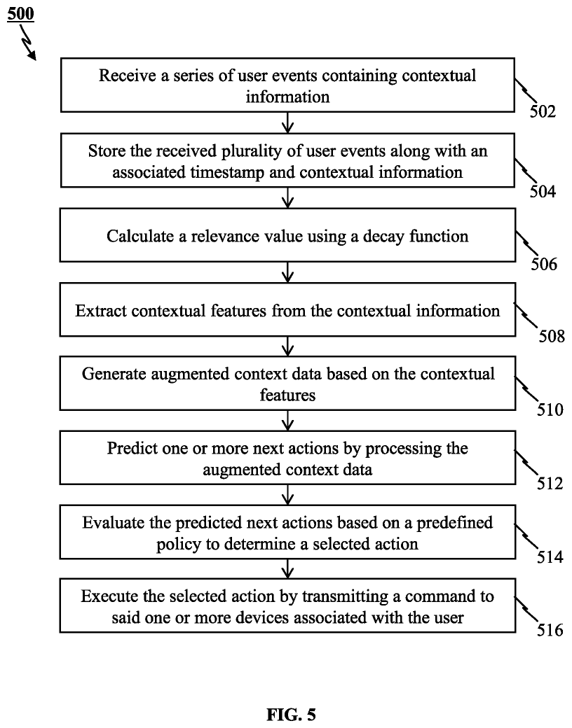

Referring to FIG. 5, in an embodiment, a method 500 for determining and executing context-based actions in a computing system is disclosed. The method 500 may be executed by the one or more processors 228 (wherein, the processor 228 is similar to the processor 706) within the server 110, wherein each step of the method 500 may be performed by the processor 228 in accordance with the instructions stored in the memory 232.

At step 502, the user replication model 112 may receive one or more user events associated with the user 102, wherein each user event may include contextual information indicative of the current state or activity of the user 102. The one or more user events may include, but are not limited to, interaction events generated by applications executing on the user device 104, system-level events generated by an operating system or background services, communication-related events, and device state change events. For example, the one or more user events may include opening or closing an application, interacting with the user interface element, sending or receiving electronic communications, joining or leaving a virtual meeting, updating calendar entries, editing documents, or controlling connected devices. Each user event may include contextual information indicative of a current state or activity of the user 102, such as an application or service identifier, a device identifier, a timestamp associated with the user event, and information describing the type of interaction performed. The contextual information may further include environmental and situational attributes, including location information, time of day, device status, network connectivity, active tasks or workflows, recent user activity, and application state at the time the event occurs, thereby enabling the user replication model 112 to determine the current condition of the user and analyze relationships among the user events.

For example, the user replication model 112 may receive the following user event details associated with sending an email by the user 102:
event_id: “EVT-305”
event_type: “email_sent”
application_source: “mailhunt.com”
timestamp: “10:32:15 AM”
recipient_identifier: “client_contact_A”
subject_line: “Project Update Meeting Confirmation”
contextual_state: [“user_at_work_location”, “active_work_hours”, “calendar_event_pending”]
device_status: [“connected_to_wifi”, “battery_level_75_percent”]
action_performed: “email_composed_and_sent”.

At step 504, the user replication model 112 may store the received series of user events in the temporal action memory 218 by recording each user event in a time-ordered sequence according to a corresponding timestamp. Each user event may be stored in association with its respective contextual information indicative of the state or activity of the user 102 at the time of occurrence. The temporal action memory 218 may maintain a chronologically indexed representation of the user events to enable subsequent retrieval, analysis, and pattern determination.

### For Example:

The user event corresponding to event_id “EVT-305” of event_type “email_sent” may be recorded in the temporal action memory along with its associated timestamp “10:32:15 AM” and contextual information including application_source “mailhunt.com,” recipient_identifier “client_contact_A,” subject_line “Project Update Meeting Confirmation,” contextual_state, device_status, and action_performed “email_composed_and_sent,” such that the user event is stored as part of the time-ordered sequence of user events associated with the user 102.

At step 506, the user replication model 112 may calculate, for each recorded user event stored in the temporal action memory 218, the relevance value using the temporal decay function or other time-based weighting function. The temporal decay function may assign a comparatively higher relevance value to the user events having more recent timestamps and a comparatively lower relevance value to the user events having older timestamps. The calculated relevance value may be stored in association with the corresponding user event and may be utilized for prioritization, behavioral modeling, prediction, or automated decision-making processes.

For example, assuming a current evaluation time of 11:00:00 AM, the user replication model 112 may determine relevance values as follows:
event_id: “EVT-305”
   event_type: “email_sent”
   timestamp: “10:32:15 AM”
   action_performed: “email_composed_and_sent”
   calculated_relevance_value: 0.94
event_id: “EVT-306”
   event_type: “document_edited”
   timestamp: “09:50:10 AM”
   action_performed: “project_document_modified”
   calculated_relevance_value: 0.76
event_id: “EVT-307”
   event_type: “browser_search”
   timestamp: “08:40:05 AM”
   action_performed: “search_query_executed”
   calculated_relevance_value: 0.52

At step 508, the user replication model 112 may extract, based on the calculated relevance values, one or more contextual features from the contextual information associated with the recorded user events, wherein the contextual features correspond to the current condition of the user 102. The user replication model 112 may prioritize user events having comparatively higher relevance values and may apply the predefined relevance threshold or weighted aggregation mechanism to selectively derive contextual attributes from such user events. The extracted contextual features may include, without limitation, indicators of location, activity state, device connectivity status, application usage, communication activity, and scheduled engagements. Contextual information associated with user events having lower relevance values may be assigned reduced weight or may be excluded from the extraction process. The extracted contextual features may be structured into a contextual profile representative of the inferred current condition of the user 102 for subsequent modeling, prediction, or automated action determination.

For example, the extracted contextual features may include
“user_at_work_location,”
“active_work_hours,”
“connected_to_wifi,”
“battery_level_75_percent,” and
“project_document_in_edit_mode”

At step 510, the user replication model 112 may generate augmented context data based on the contextual features corresponding to the current condition of the user 102 by combining a recent portion of the temporal action memory 218 selected based on the assigned relevance values, and the derived current contextual features. The recent portion of the temporal action memory 218 may include user events having relevance values exceeding a predetermined threshold or falling within a predefined recency window, thereby representing the most temporally significant user activity. The user replication model 112 may aggregate, merge, or structurally integrate the selected recent user events with the derived contextual features to form a unified augmented context data structure. The augmented context data may thereby represent both the immediate behavioral state of the user 102 and the temporally proximate sequence of user interactions, enabling enhanced predictive modeling, decision-making, or automated response generation.

For example, If the derived current contextual features include “user_at_work_location,” “active_work_hours,” and “connected_to_wifi,” the user replication model 112 may combine the selected user events and the derived contextual features into augmented context data indicating that the user 102 is actively engaged in work-related communication and document-related tasks within a connected device environment.

At step 512, the user replication model 112 may predict one or more next actions of the user 102 by processing the augmented context data using the action simulation model 220. The action simulation model 220 may learn behavioral patterns from historical user events and contextual data. The augmented context data, including the predefined recent portion of the temporal action memory 218 and the derived current contextual features, may be provided as input to the action simulation model 220. The action simulation model 220 may generate one or more predicted next actions, each associated with the confidence value or probability value. The predicted next actions may represent likely subsequent activities of the user 102 based on learned temporal patterns, contextual dependencies, and prior behavioral sequences. For example, where the augmented context data indicates that the user 102 is at a work location during active work hours, has recently sent a project-related email, the predicted next actions with their confidence values may include
“calendar_event_creation,”=0.87
“follow_up_email_draft,”=0.79
“document_upload_to_shared_workspace”=0.65

At step 514, the user replication model 112 may evaluate the predicted one or more next actions based on the predefined policy to determine a selected action. The predefined policy may include one or more decision rules, priority criteria, confidence thresholds, contextual constraints, security conditions, or user-defined preferences governing automated action selection. The user replication model 112 may compare the predicted next actions and their associated confidence values against the predefined policy to assess contextual alignment, compliance, and priority ranking. Based on such evaluation, the user replication model 112 may select one action from among the predicted next actions as the selected action, wherein the selected action satisfies the predefined policy requirements.

For example, if the predefined policy specifies that only actions having a confidence value above 0.80 and corresponding to active work tasks may be selected, the user replication model 112 may determine “calendar_event_creation” as the selected action.

At step 516, the user replication model 112 may execute the selected action by transmitting a command to the user device 104 associated with the user 102. The command may be generated based on the selected action and may be formatted in accordance with a communication protocol supported by the respective user device 104.

For example, for the selected action “calendar_event_creation,” the user replication model 112 may transmit a command to the user device 104 causing a calendar application to open and automatically populate a new calendar entry interface, optionally pre-filled with a suggested title, date, and time based on the augmented context data, thereby enabling the user 102 to confirm or finalize the calendar event.

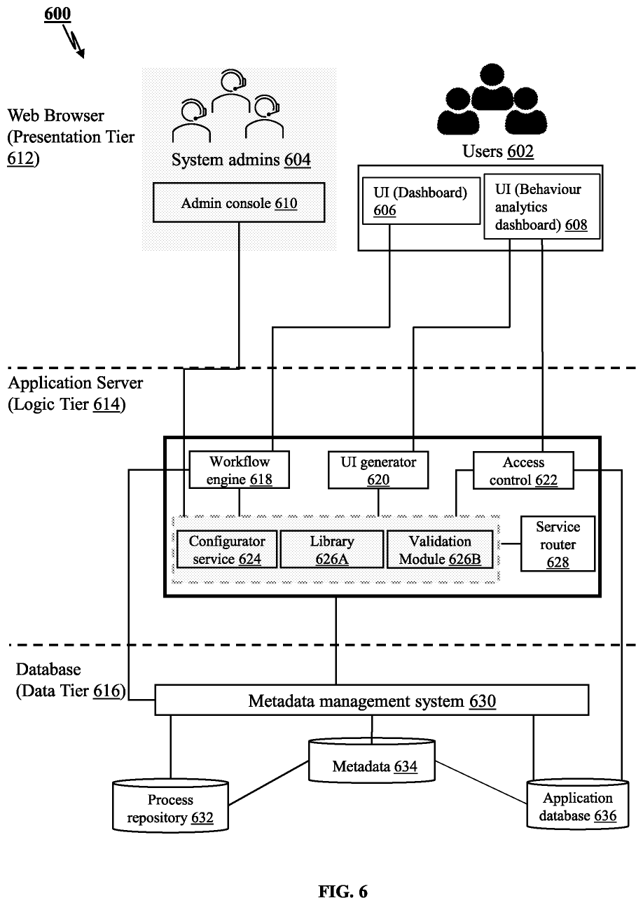

Referring to FIG. 6, in an embodiment, a computing environment 600 in which the system 100 may be implemented is disclosed. The computing environment 600 may be configured to observe, model, and automatically replicate user actions across one or more software environments. The system 600 may deliver cloud-based services to end users 602 (e.g., primary users, secondary users, client systems) and system administrators 604 (e.g., operators, supervisors). The architecture enables coordinated interaction among modular components that collectively provide secure access control, action capture, behavioural modelling, automated execution, and persistent state management. The system architecture 600 supports core functionalities including user action monitoring, intent inference, action sequence generation, execution of replicated actions, and synchronization of replicated user states. The presentation tier 612 may be accessed via a web browser and supports interaction by end users 602 and the system administrators 604.

In an embodiment, the system 600 includes an admin console 610 configured as an administrative interface enabling system administrators to define replication policies, configure behavioural modelling parameters, manage execution constraints, and monitor system performance. The admin console 610 may further allow administrators to adjust replication thresholds, override automated action decisions, and control scope and permissions associated with replicated user behaviour. The system further includes a user interface 606 and a behaviour analytics dashboard 608. The user interface 606 enables end users 602 to interact with one or more applications, while the behaviour analytics dashboard 608 may allow authorized users to view replicated actions, action histories, inferred intents, execution outcomes, and synchronization metrics across replicated environments.

The presentation tier 612 communicates with the application server 614, which executes core replication logic. In an embodiment, the application server 614 may include a workflow engine 618 configured to control ordered execution of user action sequences derived from captured interaction data. A UI generator 620 may dynamically generate interface elements for the presentation tier 612 based on workflow state and replication context. An access control module 622 may enforce authentication and authorization policies governing access to replicated actions and administrative configuration functions.

The application server 614 further includes a configuration service 624 may be configured to manage replication parameters, execution policies, and behavioural model settings defined by administrative users. An action reasoning library 626A may be implemented using one or more large language models or behavioural inference models configured to infer user intents from captured interaction data and generate executable action representations. A validation module 626B may evaluate inferred intents and the generated actions against predefined policies, confidence thresholds, and execution constraints prior to automated replication. A service router 628 may manage communication and request routing between modular services within the application server 614.

The data tier 616 may provide persistent storage and state management for the user replication model 112. A metadata management system 630 may maintain structured representations of user sessions, inferred intents, action sequences, execution states, and replication outcomes. The metadata management system 630 interfaces with a process repository 632 storing replication workflows, behavioural models, and execution templates, a metadata store 634 may store versioned intent and action metadata, and an application database 636 may store user profiles, permissions, execution logs, and historical replication data.

While the computing environment 600 described above illustrates the deployment of the system 100 within cloud-based and application-server architectures configured to replicate user actions across digital platforms, the operational scope of the system 100 may not be limited to purely digital execution environments. In an embodiment, the system 100 may further be deployed on one or more mobile robotic devices equipped with sensors, actuators, and onboard compute resources, thereby extending the replication capabilities of the user replication model 112 beyond digital workflows to encompass physical actions performed in the real world on behalf of the user 102. In such an embodiment, the robotic device may function as a physical embodiment of the user replication model 112, configured to receive and execute predicted next actions that involve physical interaction with objects, equipment, or environments, including, but not limited to, fetching objects, manipulating equipment, or performing physical tasks consistent with learned user preferences and behavioral patterns.

In an embodiment, the robotic device may be configured to receive updates of the user-specific WAM 240, the LPM 242, and the temporal action memory 218 from the server 110 over the communication network 108. The robotic device may process sensor inputs generated by one or more onboard sensing modalities, including, but not limited to, camera arrays, lidar sensors, tactile sensors, depth sensors, and inertial measurement units, through the user-specific models to interpret user context and the surrounding physical environment. The processed sensor inputs may be routed to the action simulation engine 220, which may correlate the sensory contextual features with temporal patterns stored in the temporal action memory 218 to identify physical actions consistent with learned user preferences. Based on the predicted next actions generated by the action simulation engine 220, the robotic device may autonomously select and carry out physical actions via one or more actuators, including motors, grippers, and articulated limbs, in a manner consistent with the behavioral and operational patterns of the user 102. For the predicted next actions whose associated confidence values fall below a predefined confidence threshold, or for actions determined to involve elevated operational risk, the action orchestration module 224 may defer execution and route the proposed action to a remote teleoperation interface or an explicit user approval request, consistent with the user autonomy tier settings described above, thereby ensuring that the user 102 retain supervisory control over physical actions performed on their behalf.

In an embodiment, the robotic deployment of the system 100 may further incorporate a plurality of specialized safety mechanisms configured to govern the physical operation of the robotic device and to prevent harmful interactions with users, bystanders, or the surrounding environment. The temporal action memory 218 may enforce timing constraints on physical assistance tasks such that recurring physical tasks are scheduled and performed at times learned from user behavior patterns recorded within the temporal action memory 218, thereby ensuring that physical actions remain temporally consistent with established user routines. Alternatively, for trusted, low-risk, and frequently recurring tasks having confidence values satisfying the predefined policy thresholds, the robotic device may operate in a fully autonomous mode, wherein selected physical actions are executed automatically without requiring per-action user confirmation. In either mode, force-limiting and power-limiting mechanisms enforced on the actuators of the robotic device may prevent the robotic device from exerting forces beyond predefined operational thresholds, and one or more emergency stop mechanisms may be configured to enable immediate human intervention and suspension of all autonomous physical operation upon activation.

In an embodiment, the robotic device may operate in a semi-autonomous mode, wherein the action orchestration module 224 proposes candidate physical actions to the user 102 via the user interface 106 and awaits explicit user confirmation prior to execution, consistent with the prompt-then-act autonomy tier. Alternatively, for trusted, low-risk, and frequently recurring tasks having confidence values satisfying the predefined policy thresholds, the robotic device may operate in a fully autonomous mode, wherein selected physical actions are executed automatically without requiring per-action user confirmation.

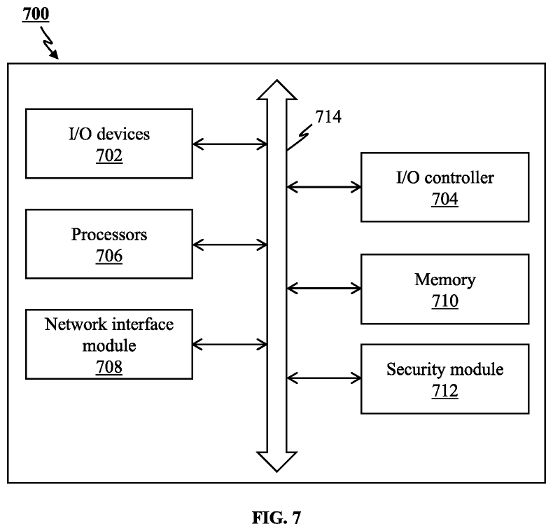

Referring to FIG. 7, in an embodiment, a system architecture 700 for the server 110 is disclosed. The server 110 may be implemented as a physical or virtual computing device, including but not limited to: a rack-mounted server, a cloud-based instance, a workstation, an edge computing device, or a hybrid on-premises/cloud deployment node. The server 110 may be operatively configured to perform one or more functions described throughout this specification, including data ingestion, workplace location inference, validation computation, and refinement of reasoning workflows.

In an embodiment, the server 110 may include one or more input/output (I/O) devices 702, an input/output controller 704, one or more processors 706 (wherein, the one or more processors 706 may be similar to the processor 228), a network interface module 708, a memory 710, a security module 712, all communicatively connected to a system bus 714. The system bus 714 may include a memory bus, peripheral bus, or any combination thereof and may utilize standardized communication protocols including, but not limited to, PCIe, I2C, or SPI.

In an embodiment, the input/output devices 702 may include hardware interfaces for receiving user input and presenting system output. The I/O devices 702 may include, for example, a keyboard, mouse, touchscreen, monitor, or audio interface, thereby enabling manual interaction with the system 100 for review input, validation input, configuration, visualization, or debugging. In certain embodiments, the I/O devices 702 may further include peripheral hardware such as biometric readers, stylus-based annotation tools, or specialized sensors to enable validation, workforce tracking, or context-specific data entry.

In an embodiment, the input/output controller 704 may configured to manage data flow between the peripheral hardware and internal system components. The input/output controller 704 may implement standard interface protocols (e.g., USB, HDMI, UART) and provide functionality for timing control, interrupt handling, and access arbitration. In certain embodiments, the input/output controller 704 may additionally enforce access permissions and session-level protocols to support secure and authorized interaction between users and the system 100.

In an embodiment, the one or more processors 706 may include, without limitation, central processing units (CPUs), graphics processing units (GPUs), tensor accelerators, or other specialized computing architectures. The one or more processors 706 may execute instructions stored in memory to perform automated user replication operations, including user intent inference, behaviour modelling, action selection, confidence estimation, policy constraint enforcement, and iterative refinement of replicated decision logic. In certain embodiments, the one or more processors 706 may be configured to execute parallelized operations to simulate or perform user actions concurrently across multiple tasks, applications, or interaction contexts, thereby enabling scalable autonomous operation in the absence of direct user input.

In an embodiment, the system 700 may include a network interface module 708 configured to enable communication between the user replication model 112 and external systems, services, or client devices over one or more networks. The network interface module 708 may include wired and/or wireless communication components such as Ethernet adapters, Wi-Fi transceivers, cellular radios, or other networking hardware. The network interface module 708 may support standard networking protocols including, but not limited to, TCP/IP, HTTP/HTTPS, REST, gRPC, WebSocket, and MQTT. In certain embodiments, the network interface module 708 may enable real-time or asynchronous interaction with third-party applications, service providers, enterprise platforms, messaging systems, or transactional services in order to execute actions on behalf of the replicated user profile.

In an embodiment, the memory 710 may include both volatile and non-volatile memory. The volatile memory may include random access memory (RAM) for active behaviour simulation, decision execution, and real-time context evaluation, while non-volatile memory may include solid-state drives (SSDs), hard disk drives (HDDs), or flash storage for persistence of user behaviour histories, preference models, action logs, contextual embeddings, and decision policies. The memory 710 may further store executable code that, when executed by the one or more processors 706, implements user replication workflows, autonomous action routines, adaptive learning cycles, and model updates based on observed user behaviour or evolving contextual signals.

In an embodiment, a security module 712 may be configured to ensure the integrity, confidentiality, and authorized use of the user replication model 112. The security module 712 may implement a range of security functions, including data encryption, identity verification, permission management, action authorization, and activity auditing, to ensure that replicated user actions are performed in accordance with user-defined constraints, regulatory requirements, and platform policies. Further, the security module 712 may further support revocation, override, or audit mechanisms allowing users or administrators to review, limit, or disable autonomous actions.

The disclosed system 100 is extendable to a wide range of industries and application domains where autonomous user action execution provides significant efficiency, continuity, and personalization benefits. Enterprise productivity platforms may use the system 100 to execute routine tasks or approvals when users are unavailable, consumer services may automate account interactions or transactions based on learned user preferences, and digital assistants may perform complex multi-step workflows without continuous user supervision. Conventional automation approaches such as rule-based scripting or static macros suffer from limited adaptability, poor contextual awareness, and inability to generalize across novel situations. The system 100 overcomes these limitations by dynamically replicating user decision-making patterns using learned behavioral models and contextual reasoning.

Additionally, the system 100 improves upon existing methods by integrating historical user actions, contextual signals, temporal patterns, and external state data with structured reasoning powered by machine-learning models. By applying context-aware inference, confidence thresholds, and exclusion of ambiguous or low-certainty actions, the system 100 achieves high-fidelity replication of user behaviour while minimizing unintended outcomes. The incorporation of auxiliary data such as past decision outcomes, exception handling patterns, and user feedback further refines action accuracy, enabling reliable differentiation between routine actions and situations requiring explicit user intervention. This comprehensive approach supports autonomous operation at scale, reduces user cognitive load, and ensures that replicated actions remain aligned with user intent and expectations over time.

Although embodiments of the present disclosure have been described with reference to illustrative implementations, it will be understood by those skilled in the art that numerous modifications, substitutions, variations, and rearrangements of components may be made without departing from the broader spirit and scope of system 100. Accordingly, the foregoing description and accompanying drawings are to be interpreted in an illustrative rather than a limiting sense, with the scope of the disclosure being defined by the appended claims and their equivalents.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. A computer-implemented method for determining and executing user-associated actions, the method comprising:
in a computer system comprising a processor and a memory module:
receiving a plurality of user events from one or more devices associated with a user, each user event including contextual information indicative of a state of the user;
storing the received plurality of user events in a temporal action memory by recording each user event in a time-ordered sequence, along with an associated timestamp and the contextual information;
calculating, for each recorded user event, a relevance value using a time-based weighting function, wherein the time-based weighting function is configured to assign higher relevance scores to more recent user events than to older user events;
extracting, based on the calculated relevance values, contextual features from the contextual information, the contextual features corresponding to a current condition of the user;
generating augmented context data based on the contextual features corresponding to the current condition of the user by combining:
a predefined recent portion of the temporal action memory selected based on the assigned relevance values; and
the derived current contextual features;
predicting one or more next actions by processing the augmented context data using a trained machine learning model;
evaluating the predicted next actions based on one or more predefined policy rules to determine a selected action; and
executing the selected action by transmitting a command to said one or more devices associated with the user.

2. The computer-implemented method according to claim 1, further comprising:
detecting an occurrence of the user event at a user-associated device;
capturing an occurrence time at a moment the user event is generated;
linking the captured occurrence time with the contextual data of the user event;
assigning the captured occurrence time as a timestamp for the user event; and
recording the user event along with the linked contextual data and assigned timestamp in an ordered sequence such that the plurality of user events are maintained in an order corresponding to their respective timestamps

3. The computer-implemented method according to claim 1, wherein calculating the relevance value is based on:
determining an elapsed time between the timestamp assigned to each stored user event and a current system time;
adjusting the relevance value of the user event based on the elapsed time; and
updating the relevance value such that user events with shorter elapsed times retain higher relevance than user events with longer elapsed times.

4. The computer-implemented method according to claim 1, wherein extracting the contextual features comprising:
evaluating, for each stored user event, the relevance value relative to a predefined relevance threshold indicative of whether the user event corresponds to a current user condition;
selecting contextual data whose relevance values satisfy the predefined relevance threshold;
excluding contextual data associated with stored user events whose relevance values fall outside the predefined relevance threshold; and
aggregating the selected contextual data to generate a unified representation corresponding to the current condition of the user.

5. The computer-implemented method according to claim 1, wherein generating the augmented context data comprising:
detecting a subset of stored user events based on their respective relevance values such that the subset corresponds to the current condition of the user;
ordering the detected subset of stored user events corresponding to their assigned timestamps; and
integrating the ordered subset of stored user events with the extracted contextual features to form a consolidated context representation.

6. The computer-implemented method according to claim 1, wherein predicting the one or more next actions comprising:
processing the augmented context data through a plurality of sequential processing stages of the trained machine learning model;
correlating temporal patterns of the stored user events with the current condition of the user; and
producing one or more next actions corresponding to the correlated temporal patterns.

7. The computer-implemented method according to claim 1, wherein evaluating the predicted next actions comprising:
determining, for each predicted next action, a confidence value based on a similarity between the augmented context data and historical outcomes associated with similar contextual features; and
linking the confidence value with the respective predicted next action.

8. The computer-implemented method according to claim 7, wherein determining the selected action comprising:
comparing the confidence values of the predicted next actions that satisfy the predefined policy;
detecting a highest confidence value among the compliant predicted next actions; and
selecting the predicted next action associated with the highest confidence value.

9. A system for determining and executing context-based actions, the system comprising:
a processor; and
a memory module configured to store instructions that, when executed by the processor, cause the processor to:
receive a plurality of user events from one or more devices associated with a user, each user event including contextual information indicative of a state of the user;
store the received plurality of user events in a temporal action memory by recording each user event in a time-ordered sequence, along with an associated timestamp and the contextual information;
calculate, for each recorded user event, a relevance value using a time-based weighting function, wherein the time-based weighting function is configured to assign higher relevance scores to more recent user events than to older user events;
extract, based on the calculated relevance values, contextual features from the contextual information, the contextual features corresponding to a current condition of the user;
generate augmented context data based on the contextual features corresponding to the current condition of the user by combining:
a predefined recent portion of the temporal action memory selected based on the assigned relevance values; and
the derived current contextual features;
predict one or more next actions by processing the augmented context data using a trained machine learning model;
evaluate the predicted next actions based on one or more predefined policy rules to determine a selected action; and
execute the selected action by transmitting a command to said one or more devices associated with the user.

10. The system according to claim 9, wherein the processor is configured to:
detect an occurrence of the event at a user-associated device;
capture an occurrence time at a moment the user event is generated;
link the captured occurrence time with the contextual data of the user event;
assign the captured occurrence time as a timestamp for the user event; and
record the user event along with the linked contextual data and assigned timestamp in an ordered sequence such that the plurality of user events are maintained in an order corresponding to their respective timestamps

11. The system according to claim 9, wherein the processor is configured to:
determine an elapsed time between the timestamp assigned to each stored user event and a current system time;
adjust the relevance value of the user event based on the elapsed time; and
update the relevance value such that user events with shorter elapsed times retain higher relevance than user events with longer elapsed times.

12. The system according to claim 9, wherein the processor is configured to:
evaluate, for each stored user event, the relevance value relative to a predefined relevance threshold indicative of whether the user event corresponds to a current user condition;
select contextual data whose relevance values satisfy the predefined relevance threshold;
exclude contextual data associated with stored user events whose relevance values fall outside the predefined relevance threshold; and
aggregate the selected contextual data to generate a unified representation corresponding to the current condition of the user.

13. The system according to claim 9, wherein the processor is configured to:
detect a subset of stored user events based on their respective relevance values such that the subset corresponds to the current condition of the user;
order the detected subset of stored user events corresponding to their assigned timestamps; and
integrate the ordered subset of stored user events with the extracted contextual features to form a consolidated context representation.

14. The system according to claim 9, wherein the processor is configured to:
process the augmented context data through a plurality of sequential processing stages of the trained machine learning model;
correlate temporal patterns of the stored user events with the current condition of the user; and
produce one or more next actions corresponding to the correlated temporal patterns.

15. The system according to claim 9, wherein the processor is configured to:
determine, for each predicted next action, a confidence value based on a similarity between the augmented context data and historical outcomes associated with similar contextual features; and
link the confidence value with the respective predicted next action.

16. The system according to claim 15, wherein the processor is configured to:
compare the confidence values of the predicted next actions that satisfy the predefined policy;
detect a highest confidence value among the compliant predicted next actions; and
select the predicted next action associated with the highest confidence value

17. A non-transitory computer-readable medium having stored thereon, computer-executable instructions which, when executed by a computer, cause the computer to execute operations, the operations comprising:
receiving a plurality of user events from one or more devices associated with a user, each user event including contextual information indicative of a state of the user;
storing the received plurality of user events in a temporal action memory by recording each user event in a time-ordered sequence, along with an associated timestamp and the contextual information;
calculating, for each recorded user event, a relevance value using a time-based weighting function, wherein the time-based weighting function is configured to assign higher relevance scores to more recent user events than to older user events;
extracting, based on the calculated relevance values, contextual features from the contextual information, the contextual features corresponding to a current condition of the user;
generating augmented context data based on the contextual features corresponding to the current condition of the user by combining:
a predefined recent portion of the temporal action memory selected based on the assigned relevance values; and
the derived current contextual features;
predicting one or more next actions by processing the augmented context data using a trained machine learning model;
evaluating the predicted next actions based on one or more predefined policy rules to determine a selected action; and
executing the selected action by transmitting a command to said one or more devices associated with the user.
